(19) United States
(12) Patent Application Publication
(10) Pub. No.: US 2025/0329487 A1
(43) Pub. Date: Oct. 23, 2025

(54) TRANSFORMER WITH IMPROVED HEAT DISSIPATION EFFICIENCY

(71) Applicant: Atum Co., Ltd., Seoul (KR)

(72) Inventor: Taeksoo HAN, Seoul (KR)

(21) Appl. No.: 19/091,894

(22) Filed: Mar. 27, 2025

(30) Foreign Application Priority Data
Apr. 22, 2024 (KR) 10-2024-0053166

(51) Int. Cl. H01F 27/08; H01F 27/06; H01F 27/24; H01F 27/28

(52) U.S. Cl. CPC H01F 27/08; H01F 27/06; H01F 27/24; H01F 27/2823

(57) ABSTRACT

Provided is to a transformer with an improved heat dissipation efficiency, and a lower magnetic core may be configured by being separated into a pair of lower first segment body and lower second segment body divided into two parts along a direction in which a lower intermediate leg and a pair of lower outer legs are arranged, a lower heat dissipation gap, which is a heat dissipation passage, may be formed between the lower first segment body and the lower second segment body, an upper magnetic core may be configured by being separated into an upper first segment body and an upper second segment body divided into two parts along a direction in which a upper intermediate leg and a pair of upper outer legs are arranged, and an upper heat dissipation gap may be formed between the upper first segment body and the upper second segment body.

### BACKGROUND OF THE INVENTION

### Field of the Invention

The present disclosure is relates to a transformer.

### Background of the Related Art

In general, a transformer adopts a magnetic core to induce a high magnetic field between primary and secondary coils.

Among conventional magnetic cores, a pair of E-E type magnetic cores in close contact with each other are widely used.

The E-E type magnetic core constitutes intermediate and outer legs, and the primary and secondary coils are wound inside the pair of E-E type magnetic cores.

However, a transformer adopting E-E type magnetic cores according to the prior art has the following problems.

The magnetic core surrounding the primary and secondary coils prevents heat generated in the primary and secondary coils from being released to the outside, thereby having a problem in that the heat inside the transformer cannot escape efficiently.

As such, when the heat inside the transformer cannot escape and condenses thereinside, a change in current occurs, causing loss between the primary and secondary coils, resulting in a problem where an output of the transformer decreases.

### SUMMARY OF THE INVENTION

The present disclosure is contrived to solve the foregoing problems in the prior art, and an aspect of a transformer with an improved heat dissipation efficiency according to the present disclosure is to provide a transformer with an improved heat dissipation efficiency, in which:
first, an E-E type magnetic core may be separated into a pair of segment bodies and a gap through which heat can be dissipated may be disposed between the separated pair of segment bodies, so as to efficiently dissipate condensed heat inside the transformer to the outside (dissipate heat through a flow of heated air, rather than through heat conduction),
second, heat generated and condensed inside the transformer may be efficiently dissipated to the outside so as to reduce the loss of the transformer and increase the efficiency of the transformer,
third, heat generation management (thermal saturation point management) inside the transformer may be easily and conveniently performed by a simple configuration,
fourth, inner surfaces of lower first and second segment bodies and inner surfaces of upper first and second segment bodies may be disposed as flat surfaces, so as not to reduce a magnetic flux density formed throughout upper and lower magnetic cores while maintaining a heat dissipation gap between the first and second segment bodies,
fifth, a clearance or movement may be prevented between a pair of lower first and second segment bodies while reliably maintaining a lower heat dissipation gap between the pair of lower first and second segment bodies,
sixth, a stable assembly of the transformer may be performed with no movement or clearance using a small number of parts, and
seventh, it may be suitable to maintain an overall movement and clearance and secure the fastening by a sequential organic coupling relationship through a pair of lower first and second segment bodies→a lower mount→a main mount→an upper mount→a pair of upper first and second segment bodies.

In order to achieve the foregoing objectives, a transformer with an improved heat dissipation efficiency may include a primary coil disposed by winding a conductive wire in a coil shape to form a first hollow portion at a center thereof, a secondary coil disposed by winding a conductive wire in a coil shape to generate an induced current by a current applied to the primary coil and form a second hollow portion at a center thereof, a lower magnetic core inserted into the primary coil from below the primary coil, and an upper magnetic core inserted into the secondary coil from above the secondary coil to form a closed magnetic flux with the lower magnetic core, wherein the lower magnetic core includes a flat plate-shaped lower base, a lower intermediate leg protruding from the centers of the lower base toward the upper magnetic core to be internally inserted into the first hollow portion of the primary coil, and a pair of lower outer legs spaced apart from the lower intermediate leg to protrude from an outer side of the lower base toward the upper magnetic core, the upper magnetic core includes flat plate-shaped upper base, upper intermediate leg protruding from the centers of the upper base toward the lower magnetic core to be internally inserted into the second hollow portion of the secondary coil, and a pair of upper outer legs spaced apart from the upper intermediate leg to protrude from an outer side of the upper base toward the lower magnetic core, the lower magnetic core is configured by separating the lower base, the lower outer legs, and the lower intermediate leg into a pair of lower first segment body and lower second segment body divided into two parts along a direction in which the lower intermediate leg and a pair of lower outer legs are arranged, a lower heat dissipation gap is formed as a heat dissipation passage for dissipating heat generated from the magnetic cores and the coils between the lower first segment body and the lower second segment body, the upper magnetic core is configured by separating the upper base portions, the upper outer legs, and the upper intermediate leg into an upper first segment body and an upper second segment body divided into two parts along a direction in which the upper intermediate leg and a pair of upper outer legs are arranged, an upper heat dissipation gap is formed as a heat dissipation passage for dissipating heat generated from the magnetic core and the coils between the upper first segment body and the upper second segment body, the primary coil is inserted into the lower first segment body and the lower second segment body simultaneously that maintain the lower heat dissipation gap, and the secondary coil is inserted into the upper first segment body and the upper second segment body simultaneously that maintain the upper heat dissipation gap.

A transformer with an improved heat dissipation efficiency according to the present disclosure having the foregoing configuration has the following effects.

First, an E-E type magnetic core may be separated into a pair of segment bodies and a gap through which heat can be dissipated may be disposed between the separated pair of segment bodies, thereby having an effect of efficiently dissipating condensed heat inside the transformer to the outside (dissipating heat through a flow of heated air, rather than through heat conduction);

Second, heat generated and condensed inside the transformer may be efficiently dissipated to the outside, thereby having an effect of decreasing the loss of the transformer and increasing the efficiency of the transformer.

Third, there is an effect that can easily and conveniently perform heat generation management (thermal saturation point management) inside the transformer by a simple configuration.

Fourth, inner surfaces of lower first and second segment bodies and inner surfaces of upper first and second segment bodies may be disposed as flat surfaces, thereby having an effect of not reducing a magnetic flux density formed throughout upper and lower magnetic cores while maintaining a heat dissipation gap between the first and second segment bodies.

Fifth, there is an effect that a clearance or movement can be prevented between a pair of lower first and second segment bodies while reliably maintaining a lower heat dissipation gap between the pair of lower first and second segment bodies.

Sixth, there is an effect that a stable assembly of the transformer can be performed with no movement or clearance using a small number of parts.

Seventh, there is an effect that can maintain an overall movement and clearance and secure the fastening by a sequential organic coupling relationship through a pair of lower first and second segment bodies→a lower mount→a main mount→an upper mount→a pair of upper first and second segment bodies.

### BRIEF DESCRIPTION OF THE DRAWINGS

FIG. 1 is a perspective view of a transformer 1 with an improved heat dissipation efficiency according to one embodiment of the present disclosure.

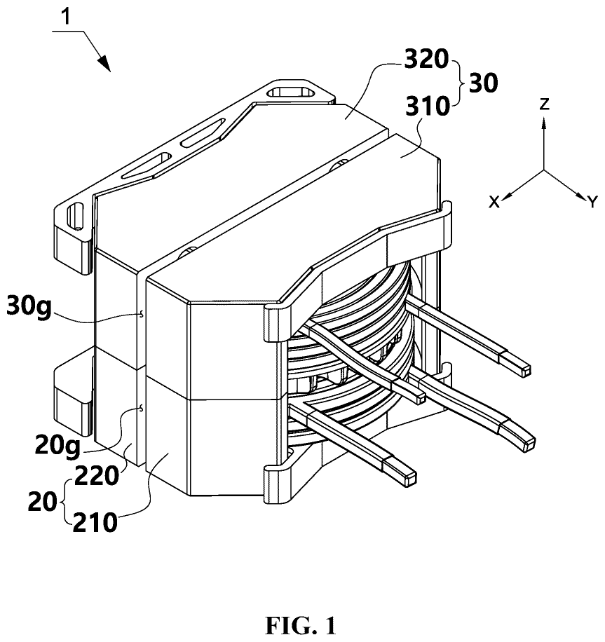

FIG. 2 is a plan view of FIG. 1.

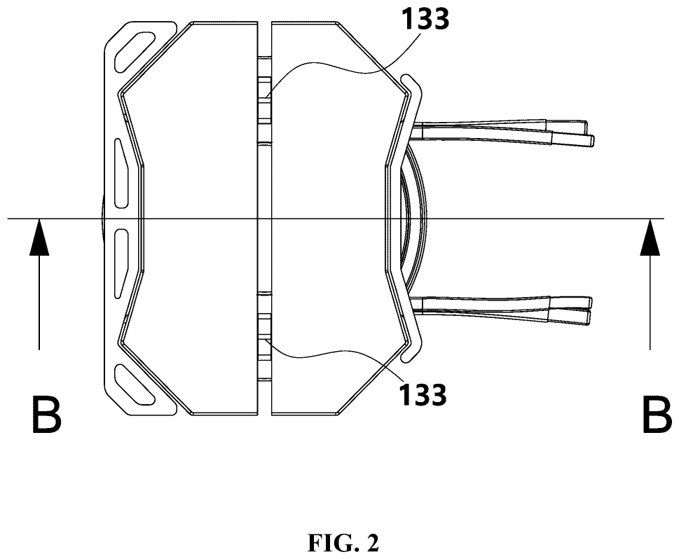

FIG. 3 is a bottom view of FIG. 1.

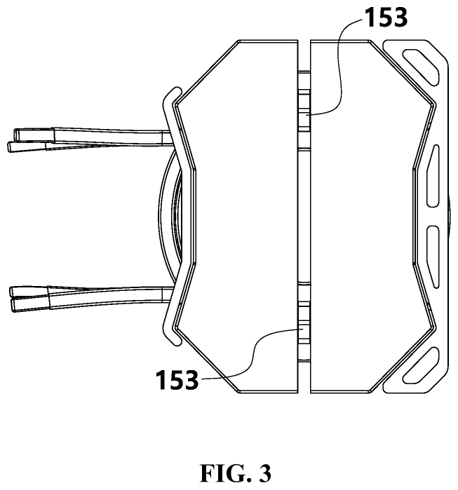

FIG. 4 is a cross-sectional view taken along line B-B in FIG. 2.

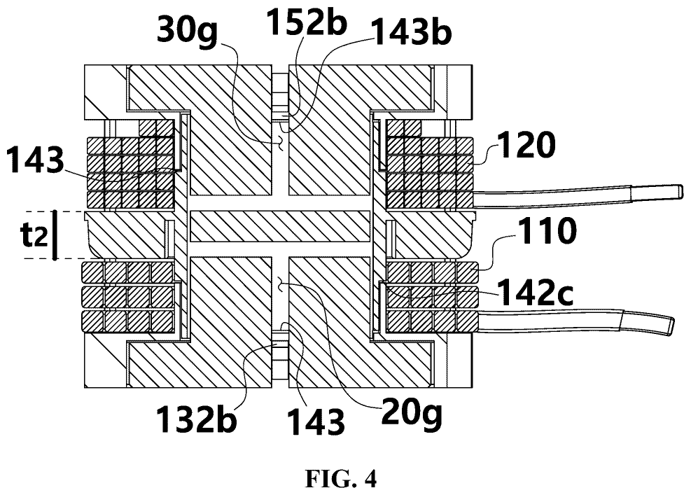

FIG. 5 is a top exploded perspective view of a transformer 1 with an improved heat dissipation efficiency according to one embodiment of the present disclosure.

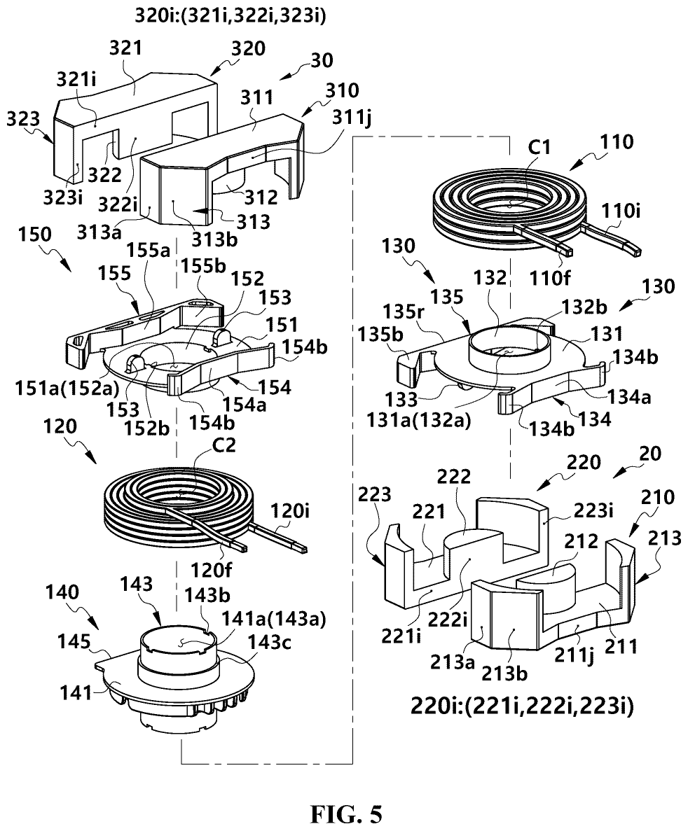

FIG. 6 is a bottom exploded perspective view of a transformer 1 with an improved heat dissipation efficiency according to one embodiment of the present disclosure.

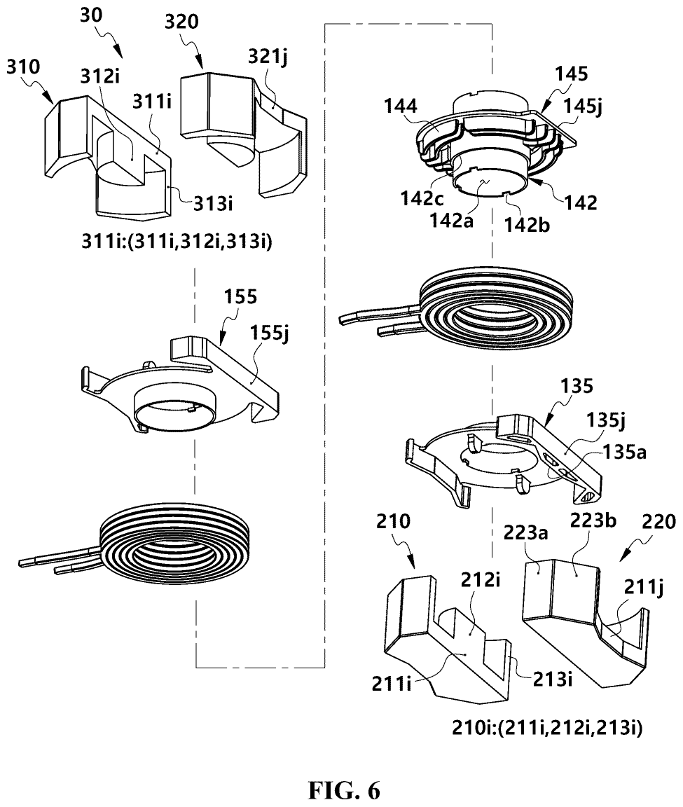

FIG. 7 is a bottom view of a main mount 140 in a transformer 1 with an improved heat dissipation efficiency according to one embodiment of the present disclosure.

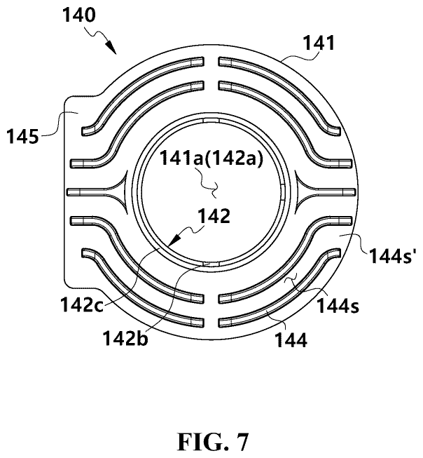

### DETAILED DESCRIPTION OF THE PREFERRED EMBODIMENT

The following is a detailed description of a preferred embodiment of a transformer with an improved heat dissipation efficiency according to the present disclosure with reference to the accompanying drawings.

When defining directions in this specification, a direction in which a primary coil 110 and a secondary coil 120 are arranged is referred to as an up-down direction (vertical direction, z-axis direction), a direction in which an intermediate leg portion and a pair of outer leg portions are arranged is referred to as a left-right direction (x-axis direction), and a direction in which a lower first segment body 210 and a lower second segment body 220 are spaced apart is referred to as a front-rear direction (y-axis direction), which is a direction that is horizontally orthogonal to the left-right direction.

Furthermore, for instance, “lower” described in a lower magnetic core, a lower mount, or the like, and “upper” described in an upper magnetic core, an upper mount, or the like are only for the convenience of explanation and are not concepts of absolute directions, and a lower magnetic core 20 does not necessarily have to be located below, and depending on a printed circuit board (PCB) environment of a device being mounted, directions of a lower magnetic core 20 and an upper magnetic core 30 may be reversed, or the lower magnetic core 20 may be disposed on the left, and the upper magnetic core 30 may be disposed on the right, and thus may be disposed in a left-right direction.

A transformer with an improved heat dissipation efficiency according to one embodiment of the present disclosure may include a primary coil 110 disposed in a flat plate shape by winding a conductive wire in a coil shape to form a first hollow portion C1 at the center thereof, a secondary coil 120 disposed in a flat plate shape by winding a conductive wire in a coil shape to generate an induced current by a current applied to the primary coil 110 and form a second hollow portion C2 at the center thereof, a lower magnetic core 20 inserted into the primary coil 110 from below the primary coil 110, wherein intermediate leg 212, 222 are internally inserted into a first hollow portion C1 of the primary coil 110 and outer leg 213, 223 are externally inserted into an outer side of the primary coil 110, and an upper magnetic core 30 inserted into the secondary coil 120 from above the secondary coil 120, wherein the intermediate leg 312, 322 are internally inserted into the second hollow portion C2 of the secondary coil 120, and the outer leg 313, 323 are inserted into an outer side of the secondary coil 120 to form a closed magnetic flux with the lower magnetic core 20.

The lower magnetic core 20 may include flat plate-shaped lower base 211, 221, lower intermediate leg 212, 222 that protrudes upward from the center of the lower base 211, 221 toward the upper magnetic core 30 to be internally inserted into the first hollow portion C1 of the primary coil 110, and a pair of lower outer legs 213, 223 that are spaced apart from the lower intermediate leg 212, 222 to both sides in a left-right direction (x-axis direction) and protrude from an outer side of the lower base 211, 221 toward the upper magnetic core 30.

The upper magnetic core 30 may include flat plate-shaped upper base 311, 321, upper intermediate leg 312, 322 that protrudes downward from the center of the upper base 311, 321 toward the lower magnetic core 20 to be internally inserted into the second hollow portion C2 of the secondary coil 120, and a pair of upper outer legs 313, 323 that are spaced apart from the upper intermediate leg 312, 322 to both sides in a left-right direction (x-axis direction) and protrude from an outer side of the upper base 311, 321 toward the lower magnetic core 20.

Furthermore, the lower magnetic core 20 is configured by being separated into a pair of a lower first segment body 210 and a lower second segment body 220 in which the lower base 211,221, the lower outer legs 213,223, and the lower intermediate leg 212,222 are divided into two parts along a left-right direction (x-axis direction), which is a direction in which the lower intermediate leg 212,222 and a pair of lower outer legs 213,223 are arranged, and a lower heat dissipation gap 20g is formed as a heat dissipation passage to dissipate heat generated from magnetic cores 20,30 (including the lower magnetic core 20 and the upper magnetic core 30, but particularly the lower magnetic core 20 in close proximity) and coils 110,120 (including both the primary coil 110 and the secondary coil 120, but particularly the primary coil 110 in close proximity) between the lower first segment body 210 and the lower second segment body 220.

The upper magnetic core 30 is configured by being separated into an upper first segment body 310 and an upper second segment body 320 in which the upper base 311, 321, the upper outer legs 313, 323, and the upper intermediate leg 312, 322 are divided into two parts along a left-right direction (x-axis direction), which is a direction in which the upper intermediate leg 312, 322 and a pair of upper outer legs 313, 323 are arranged, and an upper heat dissipation gap 30g is formed as a heat dissipation passage to dissipate heat generated from magnetic cores 20, 30 (including the lower magnetic core 20 and the upper magnetic core 30, but particularly the upper magnetic core 30 in close proximity) and coils 110, 120 (including both the primary coil 110 and the secondary coil 120, but particularly the secondary coil 120 in close proximity) between the upper first segment body 310 and the upper second segment body 320.

The primary coil 110 is inserted into the lower first segment body 210 and the lower second segment body 220 simultaneously that maintain the lower heat dissipation gap 20g.

The secondary coil 120 is inserted into the upper first segment body 310 and the upper second segment body 320 simultaneously that maintain the upper heat dissipation gap 30g.

The lower heat dissipation gap 20g and the upper heat dissipation gap 30g may be formed as described above, thereby having an advantage in that condensed heat inside the transformer can be efficiently dissipated to the outside.

As such, heat generated and condensed inside the transformer may be efficiently dissipated to the outside so as to reduce the loss of the transformer and increase the efficiency of the transformer since the loss of the transformer is reduced.

In addition, according to the foregoing configuration, there is an advantage that can easily and conveniently perform heat generation management (thermal saturation point management) inside the transformer.

The lower heat dissipation gap 20g is formed by the lower first segment body 210 and the lower second segment body 220 being spaced apart in a horizontal left-right direction (y-axis direction), and the upper heat dissipation gap 30g is formed by the upper first segment body 310 and the upper second segment body 320 being spaced apart in a horizontal left-right direction (y-axis direction).

The lower first segment body 210 includes a flat plate-shaped lower first base portion 211, a lower first intermediate leg portion 212 disposed to protrude from the center of the lower first base portion 211 toward the upper magnetic core 30 so as to be internally inserted into one side of the first hollow portion C1 of the primary coil 110, and a pair of lower first outer leg portions 213 that are spaced apart from the lower first intermediate leg portion 212 to the left and right (in an x-axis direction) and disposed to protrude from an outer side of the lower first base portion 211 toward the upper magnetic core 30.

Likewise, the lower second segment body 220 includes a flat plate-shaped lower second base portion 221, a lower second intermediate leg portion 222 disposed to protrude from the center of the lower second base portion 221 toward the upper magnetic core 30 so as to be internally inserted into the other side of the first hollow portion C1 of the primary coil 110, and a pair of lower second outer leg portions 223 that are spaced apart from the lower second intermediate leg portion 222 to the left and right and disposed to protrude from an outer side of the lower second base portion 221 toward the upper magnetic core 30.

The lower first intermediate leg portion 212 and the lower second intermediate leg portion 222 that maintain the lower heat dissipation gap 20g are internally inserted into the first hollow portion C1 of the primary coil 110, and the primary coil 110 is internally inserted into a space between the lower first intermediate leg portion 212 and the lower first outer leg portion 213 and a space between the lower second intermediate leg portion 222 and the lower second outer leg portion 223 at the same time.

Furthermore, the upper first segment body 310 includes a flat plate-shaped upper first base portion 311, an upper first intermediate leg portion 312 disposed to protrude from the center of the upper first base portion 311 toward the lower magnetic core 20 so as to be internally inserted into one side of the second hollow portion C2 of the secondary coil 120, and a pair of upper first outer leg portions 313 that are spaced apart from the upper first intermediate leg portion 312 to the left and right (in an x-axis direction) and disposed to protrude from an outer side of the upper first base portion 311 toward the upper magnetic core 30.

Likewise, the upper second segment body 320 includes a flat plate-shaped upper second base portion 321, an upper second intermediate leg portion 322 disposed to protrude from the center of the upper second base portion 321 toward the lower magnetic core 20 so as to be internally inserted into the other side of the second hollow portion C2 of the secondary coil 120, and a pair of upper second outer leg portions 323 that are spaced apart from the upper second intermediate leg portion 322 to the left and right and disposed to protrude from an outer side of the upper second base portion 321 toward the lower magnetic core 20.

The upper first intermediate leg portion 312 and the upper second intermediate leg portion 322 that maintain the upper heat dissipation gap 30g are internally inserted into the second hollow portion C2 of the secondary coil 120, and the secondary coil 120 is internally inserted into a space between the upper first intermediate leg portion 312 and the upper first outer leg portion 313 and a space between the upper second intermediate leg portion 322 and the upper second outer leg portion 323 at the same time.

Meanwhile, the partitioning of the magnetic core 20, 30 may include a case where the magnetic cores 20, 30 are actually cut and formed, and a case where the two segment bodies are respectively formed and then arranged to maintain a gap, rather than using the cutting method, and both cases of course fall within the technical scope of the present disclosure.

In the transformer 1 with an improved heat dissipation efficiency according to one embodiment of the present disclosure, an inner surface 210i of the lower first segment body 210, which is a surface of the lower first base portion 211, the lower first intermediate leg portion 212, and the lower first outer leg portion 213 facing the lower second segment body 220, may be formed as a flat surface (therefore, the inner surface 210i of the lower first segment body 210 denotes an inner surface 211i of the lower first base portion 211, an inner surface 212i of the lower first intermediate leg portion 212, and an inner surface 213i of the lower first outer leg portion 213), an inner surface 220i of the lower second segment body 220, which is a surface opposite to the inner surface 210i of the lower first segment body 210, and a surface of the lower second base portion 221, the lower second intermediate leg portion 222, and the lower second outer leg portion 223 facing the lower first segment body 210, may be formed as a flat surface (therefore, the inner surface 220i of the lower second segment body 220 denotes an inner surface 221i of the lower second base portion 221, an inner surface 222i of the lower second intermediate leg portion 222, and an inner surface 223i of the lower second outer leg portion 223), and the lower heat dissipation gap 20g may be formed between the inner surface 210i of the lower first segment body 210 and the inner surface 220i of the lower second segment body 220.

Likewise, an inner surface 310i of the upper first segment body 310, which is a surface of the upper first base portion 311, the upper first intermediate leg portion 312, and the upper first outer leg portion 313 facing the upper second segment body 320, is formed as a flat surface (therefore, the inner surface 310i of the upper first segment body 310 denotes an inner surface 311i of the upper first base portion 311, an inner surface 312i of the upper first intermediate leg portion 312, and an inner surface 313i of the upper first outer leg portion 313), an inner surface 320i of the upper second segment body 320, which is a surface opposite to the inner surface 310i of the upper first segment body 310, and a surface of the upper second base portion 321, the upper second intermediate leg portion 322, and the upper second outer leg portion 323 facing the upper first segment body 310, is formed as a flat surface (therefore, the inner surface 320i of the upper second segment body 320 denotes an inner surface 321i of the upper second base portion 321, an inner surface 322i of the upper second intermediate leg portion 322, and an inner surface 323i of the upper second outer leg portion 323), and the upper heat dissipation gap 30g may be formed between the inner surface 310i of the upper first segment body 310 and the inner surface 320i of the upper second segment body 320.

As described above, the inner surfaces 210i, 220i of the lower first and second segment bodies 210, 220 and the inner surfaces 310i, 320i of the upper first and second segment bodies 310, 320 may all be formed as flat surfaces, thereby preventing a magnetic flux density formed throughout the upper magnetic core 30 and the lower magnetic core 20 from decreasing even when heat dissipation gaps 20g, 30g are maintained between the first and second segment bodies.

The lower first segment body 210 and the lower second segment body 220 are disposed in the same shape to be mirror-symmetrical with respect to the lower spacer 133, and the upper first segment body 310 and the upper second segment body 320 are disposed in the same shape to be mirror-symmetrical with respect to the upper spacer 153.

For instance, a pair of a lower first segment body 210 and a lower second segment body 220 are disposed by dividing across the center of the intermediate leg portions 212, 222 of the lower magnetic core 20, and a pair of an upper first segment body 310 and an upper second segment body 320 are disposed by dividing across the center of the intermediate leg portions 312, 322 of the upper magnetic core 30.

In the transformer 1 with an improved heat dissipation efficiency according to one embodiment of the present disclosure, it may further include a lower mount 130 for holding the primary coil 110 by being externally inserted into the lower first intermediate leg portion 212 and the lower second intermediate leg portion 222 at the same time, and being internally inserted into the first hollow portion C1 of the primary coil 110 while allowing the lower first segment body 210 and the lower second segment body 220 to maintain a lower heat dissipation gap 20g, and an upper mount 150 for holding the secondary coil 120 by being externally inserted into the upper first intermediate leg portion 312 and the upper second intermediate leg portion 322 at the same time, and being internally inserted into the second hollow portion C2 of the secondary coil 120 while allowing the upper first segment body 310 and the upper second segment body 320 to maintain an upper heat dissipation gap 30g.

The lower mount 130 may include a flat thin lower plate 131 having a lower central hole 131a disposed at the center thereof and being in surface contact with the lower first base portion 211 and the lower second base portion 221 at the same time, a circular tube-shaped lower support tube 132 disposed to protrude from the lower central hole 131a toward the primary coil 110 so as to hold the primary coil 110 while forming a lower through hole 132a that communicates with the lower central hole 131a of the lower plate 131 to be internally inserted into the first hollow portion C1 of the primary coil 110, a lower first wing 134 disposed to protrude from a front edge of the lower plate 131 toward the lower first segment body 210, and being in close contact with the outer surface 211j of the lower first base portion 211 and/or the lower first outer leg portion 213 to hold an outer side of the lower first segment body 210, a lower second wing 135 disposed to protrude from a rear edge of the lower plate 131 toward the lower second segment body 220 and being in close contact with the outer surface 221j of the lower second base portion 221 and the lower second outer leg portion 223 to hold an outer side of the lower second segment body 220, and a lower spacer 133 disposed to protrude from the lower plate 131 toward the lower magnetic core 20 between the lower first wing 134 and the lower second wing 135 so as to support the lower first segment body 210 and the lower second segment body 220 and maintain a lower heat dissipation gap 20g between the lower first segment body 210 and the lower second segment body 220.

The lower first segment body 210 is inserted between the lower spacer 133 and the lower first wing 134 such that the inner surface 210i is supported by the lower spacer 133 and the outer surface is supported by the lower first wing 134, that is, the lower first wing 134 and the lower spacer 133 face each other to support the lower first segment body 210 such that the lower first segment body 210 is inserted between the lower spacer 133 and the lower first wing 134, the lower second segment body 220 is inserted between the lower spacer 133 and the lower second wing 135 such that the inner surface 220i is supported by the lower spacer 133 and the outer surface is supported by the lower second wing 135, that is, the lower second wing 135 and the lower spacer 133 face each other to support the lower second segment body 220 such that the lower second segment body 220 is inserted between the lower spacer 133 and the lower second wing 135, and furthermore, the lower first intermediate leg portion 212 and the lower second intermediate leg portion 222 are internally inserted into the lower support tube 132 at the same time, such that the lower first segment body 210 and the lower second segment body 220 are provided in the lower mount 130 while maintaining a lower heat dissipation gap 20g as large as the lower spacer 133.

According to the foregoing configuration, it may be possible to prevent a clearance or movement of a pair of the lower first and second segment bodies 210, 220 while reliably maintaining a lower heat dissipation gap 20g between a pair of the lower first and second segment bodies 210, 220 that are separated from each other by a simple configuration.

The lower spacer 133 is configured with a plate-shaped lower spacer protrusion 133 disposed to protrude from the lower plate 131 toward the lower magnetic core 20 between the lower first wing 134 and the lower second wing 135 so as to support the lower first segment body 210 and the lower second segment body 220 and maintain a lower heat dissipation gap 20g between the lower first segment body 210 and the lower second segment body 220.

The lower spacer 133 may be configured as a pair that are spaced apart from each other.

The lower spacer 133 is disposed to protrude from the lower plate 131 toward the lower magnetic core 20 at the exact center between the lower first wing 134 and the lower second wing 135.

The upper mount 150 may include a flat upper plate 151 having an upper central hole 151a disposed at the center thereof, a circular tube-shaped upper support tube 152 disposed to protrude from the upper central hole 151a toward the secondary coil 120 so as to hold the secondary coil 120 while forming an upper through hole 152a that communicates with the upper central hole 151a of the upper plate 151 to be internally inserted into the second hollow portion C2 of the secondary coil 120, an upper first wing 154 disposed to protrude from a front edge of the upper plate 151 toward the upper first segment body 310 and being in close contact with the outer surface 311j of the upper first base portion 311 to hold an outer side of the upper first segment body 310, an upper second wing 155 disposed to protrude from a rear edge of the upper plate 151 toward the upper second segment body 320 and being in close contact with the outer surface 321j of the upper second base portion 321 and/or the upper second outer leg portion 323 to hold an outer side of the upper second segment body 320, and an upper spacer 153 disposed to protrude from the upper plate 151 toward the lower magnetic core 20 between the upper first wing 154 and the upper second wing 155 so as to support the upper first segment body 310 and the upper second segment body 320 and maintain a lower heat dissipation gap 20g between the upper first segment body 310 and the upper second segment body 320.

The upper first segment body 310 is inserted between the upper spacer 153 and the upper first wing 154 such that the inner surface 310i is supported by the upper spacer 153 and the outer surface is supported by the upper first wing 154, that is, the upper first wing 154 and the upper spacer 153 face each other to support the upper first split body 310 such that the upper first segment body 310 is inserted between the upper spacer 153 and the upper first wing 154, the upper second segment body 320 is inserted between the upper spacer 153 and the upper second wing 155 such that the inner surface 320i is supported by the upper spacer 153 and the outer surface is supported by the upper second wing 155, that is, the upper second wing 155 and the upper spacer 153 face each other to support the upper second segment body 320 such that the upper second segment body 320 is inserted between the upper spacer 153 and the upper second wing 155, and furthermore, the upper first intermediate leg portion 312 and the upper second intermediate leg portion 322 are internally inserted into upper support tube 152 at the same time, such that the upper first segment body 310 and the upper second segment upper 320 are provided in the upper mount 150 while maintaining an upper heat dissipation gap 30g as large as the upper spacer 153.

According to the foregoing configuration, it may be possible to prevent a clearance or movement of a pair of the upper first and second segment bodies 310, 320 while reliably maintaining an upper heat dissipation gap 30g between a pair of the upper first and second segment bodies 310, 320 that are separated from each other by a simple configuration.

The upper spacer 153 is configured with a plate-shaped upper spacer protrusion 153 disposed to protrude from the upper plate 151 toward the lower magnetic core 20 between the upper first wing 154 and the upper second wing 155 so as to support the upper first segment body 310 and the upper second segment body 320 and maintain a lower heat dissipation gap 20g between the upper first segment body 310 and the upper second segment body 320.

The upper spacer 153 may be configured as a pair that are spaced apart from each other.

The upper spacer 153 is disposed to protrude from the upper plate 151 toward the upper magnetic core 30 at the exact center between the upper first wing 154 and the upper second wing 155.

In the transformer 1 with an improved heat dissipation efficiency according to one embodiment of the present disclosure, it may further include a main mount 140 having a lower side that is axially inserted and provided into the lower support tube 132 of the lower mount 130, and an upper side that is axially inserted and provided into the upper support tube 152 of the upper mount 150 so as to connect between the lower mount 130 and the upper mount 150.

The main mount 140 maintains an insulating distance between the primary coil 110 and the secondary coil 120 to insulate between the primary coil 110 and the secondary coil 120.

Specifically, the main mount 140 includes a circular flat plate-shaped partition plate 141 having a main central hole 141a disposed at the center thereof to partition the primary coil 110 and the secondary coil 120, a circular tube-shaped main lower support tube 142 having a main lower through hole 142a disposed to communicate with the main central hole 141a of the partition plate 141, and protruding from the main central hole 141a toward the primary coil 110 so as to be internally inserted into the first hollow portion C1 of the primary coil 110, and axially inserted and provided into the lower support tube 132 of the lower mount 130 to hold an upper side of the primary coil 110 at the same time, and a circular tube-shaped main upper support tube 143 having a main upper through hole 143a disposed to communicate with the main central hole 141a of the partition plate 141, and protruding from the main central hole 141a toward the secondary coil 120 so as to be internally inserted into the second hollow portion C2 of the secondary coil 120, and axially inserted and provided into upper support tube 152 of the upper mount 150 to hold a lower side of the secondary coil 120 at the same time.

In the transformer 1 with an improved heat dissipation efficiency according to one embodiment of the present disclosure, the primary coil 110 may be inserted between the lower plate 131 and the partition plate 141 while being mounted on the lower plate 131 in a height direction, and the first hollow portion C1 may be externally inserted and fitted into the lower support tube 132 and the main lower support tube 142 in a radial direction, the secondary coil 120 may be inserted between the partition plate 141 and the upper plate 151 while being mounted on the partition plate 141 in a height direction, and the second hollow portion C2 may be inserted and fitted into the upper support tube 152 and the main upper support tube 143 in a radial direction, the lower first segment body 210 and the lower second segment body 220 may be internally inserted into the first hollow portion C1 of the primary coil 110 by internally inserting the lower first intermediate leg portion 212 and the lower second intermediate leg portion 222 simultaneously into the lower support tube 132 and the main lower support tube 142 mutually arranged below the lower mount 130 (from an outer side, i.e., in an opposite direction of the primary coil), and the upper first segment body 310 and the upper second segment body 320 may be internally inserted into the second hollow portion C2 of the secondary coil 120 by internally inserting the upper first intermediate leg portion 312 and the upper second intermediate leg portion 322 into the upper support tube 152 and the main upper support tube 143 mutually arranged above the main mount 140 (from an outer side, i.e., in an opposite direction of the secondary coil).

As described above, a pair of support tubes 142, 143 are formed in the upper and lower directions centered on the partition plate 141, and the lower and upper magnetic cores 20, 30 and the primary coil 110 and the secondary coil 120 are simultaneously held by the pair of support tubes 142, 143, and further, the lower and upper mounts 130, 150 hold the lower and upper magnetic cores 20, 30, so that the entire transformer assembly can be stably assembled without movement or play with a small number of parts.

The lower plate 131 of the lower mount 130 may have a circular plate (disk) shape to fit with the primary coil 110, the upper plate 151 of the upper mount 150 may have a circular plate (disk) shape to fit with the secondary coil 120, and the partition plate 141 of the main mount 140 may have a circular plate (disk) shape to fit with the primary and secondary coils 110, 120.

In the transformer 1 with an improved heat dissipation efficiency according to one embodiment of the present disclosure, a lower step edge 142c may be disposed on an outer circumferential surface of the main lower support tube 142, an upper step edge 143c may be disposed on an outer circumferential surface of the main upper support tube 143, the lower step edge 142c of the main lower support tube 142 may be supported by a step on an upper end of the lower support tube 132 such that the main lower support tube 142 and the lower support tube 132 are arranged in an overlapping manner, an outer circumferential surface of the lower support tube 132 and an outer circumferential surface of the main lower support tube 142 may form the same surface while the main lower support tube 142 and the lower support tube 132 are arranged in an overlapping manner, a lower end of the upper support tube 152 may be supported by a step on the upper step edge 143c of the main upper support tube 143 such that the main upper support tube 143 and the upper support tube 152 are arranged in an overlapping manner, and an outer circumferential surface of the upper support tube 152 and an outer circumferential surface of the main upper support tube 143 may form the same surface while the main upper support tube 143 and the upper support tube 152 are arranged in an overlapping manner.

In the transformer 1 with an improved heat dissipation efficiency according to one embodiment of the present disclosure, a main lower fitting groove 142b may be disposed to be concave on a circumferential edge of the main lower support tube 142, a lower fitting protrusion 132b may be disposed to fit into the main lower fitting groove 142b on an inner circumferential surface of the lower support tube 132 of the lower mount 130, a main upper fitting groove 143b may be disposed to be concave on an outer peripheral edge of the main upper support tube 143, and an upper fitting protrusion 152b may be disposed to fit into the main upper fitting groove 143b on an inner circumferential surface of the upper support tube 152 of the upper mount 150.

Accordingly, it may maintain an overall movement and clearance and secure the fastening by a sequential organic coupling relationship through a pair of a lower first segment body 210 and a lower second segment body 220→a lower mount 130→a main mount 140→an upper mount 150→a pair of an upper first segment body 310 and an upper second segment body 320.

In the transformer 1 with an improved heat dissipation efficiency according to one embodiment of the present disclosure, a gap adjustment rib 144 for adjusting an insulation distance (spacing) between the primary coil 110 and the secondary coil 120 may be spaced apart from the main central hole 141a and disposed to protrude in a vertical direction.

A thickness t2 of the partition plate 141 and the spacing adjustment rib 144 may be adjusted to adjust an insulation distance between the primary coil 110 and the secondary coil 120.

In the transformer 1 with an improved heat dissipation efficiency according to one embodiment of the present disclosure, the spacing adjustment rib 144 may be configured in plurality, and a resin filling passage 144s into which heat dissipation resin liquid can be filled may be formed between the plurality of spacing adjustment ribs 144.

An inlet 144s′ of the resin filling passage 144s may be open so as to inject heat-dissipating resin from the outside.

According thereto, heat dissipation efficiency may be improved, and in particular, internal injection of heat dissipation resin for heat dissipation efficiency and external heat dissipation may be facilitated.

Meanwhile, in an embodiment of the drawing, the spacing adjustment rib 144 may be disposed to protrude toward the primary coil 110 such that the primary coil 110 comes into contact therewith, but is not of course limited thereto, and a technical configuration in which the spacing adjustment rib 144 is disposed to protrude toward the secondary coil 120 such that the secondary coil 120 comes into contact therewith also falls within the technical scope of the present disclosure.

In the transformer 1 with an improved heat dissipation efficiency according to one embodiment of the present disclosure, the lower first wing 134 of the lower mount 130 may include a lower first wing central portion 134a that protrudes from a front edge of the lower plate 131 toward the lower first segment body 210 so as to be in close contact with the center of an outer surface 211j of the lower first base portion 211 of the lower first segment body 210, and a lower first wing bent portion 134b that is symmetrically disposed to extend left and right from the lower first wing central portion 134a so as to be in close contact with an outer side of the outer surface 211j of the lower first base portion 211 of the lower first segment body 210 and the lower first outer leg portion 213 at the same time, the lower second wing 135 of the lower mount 130 may include a lower second wing central portion 135a that protrudes from a rear edge of the lower plate 131 toward the lower second segment body 220 so as to be in close contact with the center of the outer surface 221j of the base portion 221, and a lower second wing bent portion 135b that is symmetrically disposed to extend left and right from the lower second wing central portion 135a so as to be in close contact with an outer side of the outer surface 221j of the lower second base portion 221 of the lower second segment body 220 and the lower second outer leg portion 223 at the same time, an outer surface of the lower first outer leg portion 213 of the lower first segment body 210 may include a lower first flat surface 213a and a lower first inclined surface 213b disposed to be inclined so as to face inward from the lower first flat surface 213a toward the lower first intermediate leg portion 212, an outer surface of the lower second outer leg portion 223 of the second segment body 220 may include a lower second flat surface 223a and a lower second inclined surface 223b disposed to be inclined inward from the lower second flat surface 223a toward the lower second intermediate leg portion 222, the lower first wing bent portion 134b may be concavely bent inward so as to be in close contact with an outer side of the outer surface 211j of the lower first base portion 211 and the lower first inclined surface 213b of the lower first outer leg portion 213, and the lower second wing bent portion 135b may be concavely bent inward so as to be in close contact with an outer side of the outer surface 221j of the lower second base portion 221 and the lower second inclined surface 223b of the lower second outer leg portion 223.

Likewise, the upper first wing 154 of the upper mount 150 may include an upper first wing central portion 154a that protrudes from a front edge of the upper plate 151 toward the upper first segment body 310 so as to be in close contact with the center of an outer surface 311j of the upper first base portion 311 of the upper first segment body 310, and an upper first wing bent portion 154b that is symmetrically disposed to extend left and right from the upper first wing central portion 154a so as to be in close contact with an outer side of the outer surface 311j of the upper first base portion 311 of the upper first segment body 310 and the upper first outer leg portion 313 at the same time, the lower second wing 155 of the upper mount 150 may include an upper second wing central portion 155a that protrudes from a rear edge of the upper plate 151 toward the upper second segment body 320 so as to be in close contact with the center of an outer surface 321j of the upper second base portion 321 of the upper second segment body 320, and an upper second wing bent portion 155b that is symmetrically disposed to extend left and right from the upper second wing central portion 155a so as to be in close contact with an outer side of the outer surface 321j of the upper second base portion 321 of the upper second segment body 320 and the upper second outer leg portion 323 at the same time, an outer surface of the upper first outer leg portion 313 of the upper first segment body 310 may include an upper first flat surface 313a and an upper first inclined surface 313b disposed to be inclined so as to face inward from the upper first flat surface 313a toward the upper first intermediate leg portion 312, an outer surface of the upper second outer leg portion 323 of the upper second segment body 320 may include an upper second flat surface 323a and an upper second inclined surface 323b disposed to be inclined inward from the upper second flat surface 323a toward the upper second intermediate leg portion 322, the upper first wing bent portion 154b may be concavely bent inward so as to be in close contact with an outer side of the outer surface 311j of the upper first base portion 311 and an upper first inclined surface 313b of the upper first outer leg portion 313 at the same time, and the upper second wing bent portion 155b may be concavely bent inward so as to be in close contact with an outer side of the outer surface 321j of the upper second base portion 321 and an upper second inclined surface 323b of the upper second outer leg portion 323 at the same time.

In the transformer 1 with an improved heat dissipation efficiency according to one embodiment of the present disclosure, a boss 145 may be disposed that protrudes rearward from a rear surface of the partition plate 141 and has an outer surface 145j formed as a flat surface, an outer surface 135j of the lower second wing 135 may be a flat surface, an outer surface 155j of the upper second wing 155 may be a flat surface, and the outer surface 145j of the boss 145, the outer surface 135j of the lower second wing 135, and the outer surface 155j of the upper second wing 155 may be all disposed to be located on the same line.

Among the configurations of the transformer protruding rearward, the outer surface 145j of the boss 145 located at a rearmost position, the outer surface 135j of the lower second wing 135, and the outer surface 155j of the upper second wing 155 may all be located on the same line and also all be configured as flat surfaces, so as to allow easy and convenient mounting when mounting the transformer according to one embodiment of the present disclosure on a rear fixture.

A result of an internal temperature test (a condition of coolant 25° C.) of the transformer conducted by the applicant of the present disclosure is disclosed in [Table 1].

TABLE 1

| | | | Transformer in |
|---|---|---|---|
| | | Transformer of | the related art |
| | | the present | (adopting known |
| | | disclosure | E-E cores) |
| Temperature | Primary coil [° C.] | 70.9 | 91.6 |
| | Secondary | 93.9 | 125.3 |
| | coil [° C.] | | |
| | Lower magnetic | 6.9 | 102.1 |
| | core [° C.] | | |
| | Upper magnetic | 69 | 109.6 |
| | core [° C.] | | |

As can be seen from the temperature test result in [Table 1], it can be confirmed that a sample adopting a segmented magnetic core according to the present disclosure has excellent temperature characteristics.

As such, a preferred embodiment according to the present disclosure has been described, and it will be apparent to those skilled in the art that the present disclosure can be implemented in other specific forms without changing the technical concept or essential features thereof, in addition to the embodiment described above. Therefore, the foregoing embodiment should be understood as illustrative rather than restrictive.

The scope of the present disclosure is defined by the appended claims rather than by the detailed description, and all changes or modifications derived from the meaning and range of the appended claims and equivalents thereof should be construed to be embraced by the scope of the present disclosure.

What is claimed is:

1. A transformer comprising a primary coil 110 disposed by winding a conductive wire in a coil shape to form a first hollow portion C1 at a center thereof, a secondary coil 120 disposed by winding a conductive wire in a coil shape to generate an induced current by a current applied to the primary coil 110 and form a second hollow portion C2 at a center thereof, a lower magnetic core 20 inserted into the primary coil 110 from below the primary coil 110, and an upper magnetic core 30 inserted into the secondary coil 120 from above the secondary coil 120 to form a closed magnetic flux with the lower magnetic core 20,
wherein the lower magnetic core 20 comprises:
a flat plate-shaped lower base;
a lower intermediate leg protruding from the centers of the lower base toward the upper magnetic core 30 to be internally inserted into the first hollow portion C1 of the primary coil 110; and
a pair of lower outer legs spaced apart from the lower intermediate leg to protrude from an outer side of the lower base toward the upper magnetic core 30,
wherein the upper magnetic core 30 comprises:
a flat plate-shaped upper base;
a upper intermediate leg protruding from the centers of the upper base toward the lower magnetic core 20 to be internally inserted into the second hollow portion C2 of the secondary coil 120; and
a pair of upper outer legs spaced apart from the upper intermediate leg to protrude from an outer side of the upper base toward the lower magnetic core 20,
wherein the lower magnetic core 20 is configured by separating the lower base, the lower outer leg, and the lower intermediate leg into a pair of lower first segment body 210 and lower second segment body 220 divided into two parts along a direction in which the lower intermediate leg and a pair of lower outer legs are arranged,
wherein a lower heat dissipation gap 20g is formed as a heat dissipation passage for dissipating heat generated from the magnetic cores 20, 30 and the coils 110, 120 between the lower first segment body 210 and the lower second segment body 220,
wherein the upper magnetic core 30 is configured by separating the upper base, the upper outer legs, and the upper intermediate leg into an upper first segment body 310 and an upper second segment body 320 divided into two parts along a direction in which the upper intermediate leg and a pair of upper outer legs are arranged,
wherein an upper heat dissipation gap 30g is formed as a heat dissipation passage for dissipating heat generated from the magnetic core 20, 30 and the coils 110, 120 between the upper first segment body 310 and the upper second segment body 320,
wherein the primary coil 110 is inserted into the lower first segment body 210 and the lower second segment body 220 simultaneously that maintain the lower heat dissipation gap 20g, and
wherein the secondary coil 120 is inserted into the upper first segment body 310 and the upper second segment body 320 simultaneously that maintain the upper heat dissipation gap 30g.

2. The transformer of claim 1, wherein the lower heat dissipation gap 20g is formed by the lower first segment body 210 and the lower second segment body 220 being spaced apart in a horizontal left-right direction,
wherein the upper heat dissipation gap 30g is formed by the upper first segment body 310 and the upper second segment body 320 being spaced apart in a horizontal left-right direction,
wherein the lower first segment body 210 comprises:
a flat plate-shaped lower first base portion 211;
a lower first intermediate leg portion 212 disposed to protrude from the lower first base portion 211 toward the upper magnetic core 30 so as to be internally inserted into one side of the first hollow portion C1 of the primary coil 110; and
a pair of lower first outer leg portions 213 that are spaced apart from the lower first intermediate leg portion 212 to protrude from an outer side of the lower first base portion 211 toward the upper magnetic core 30,
wherein the lower second segment body 220 comprises:
a flat plate-shaped lower second base portion 221;
a lower second intermediate leg portion 222 disposed to protrude from the lower second base portion 221 toward the upper magnetic core 30 to be internally inserted into the other side of the first hollow portion C1 of the primary coil 110; and
a pair of lower second outer leg portions 223 that are spaced apart from the lower second intermediate leg portion 222 disposed to protrude from an outer side of the lower second base portion 221 toward the upper magnetic core 30,
wherein the lower first intermediate leg portion 212 and the lower second intermediate leg portion 222 that maintain the lower heat dissipation gap 20g are internally inserted into the first hollow portion C1 of the primary coil 110,
wherein the primary coil 110 is internally inserted into a space between the lower first intermediate leg portion 212 and the lower first outer leg portion 213 and a space between the lower second intermediate leg portion 222 and the lower second outer leg portion 223 at the same time,
wherein the upper first segment body 310 comprises:
a flat plate-shaped upper first base portion 311;
an upper first intermediate leg portion 312 disposed to protrude from the upper first base portion 311 toward the lower magnetic core 20 so as to be internally inserted into one side of the second hollow portion C2 of the secondary coil 120; and
a pair of upper first outer leg portions 313 that are spaced apart from the upper first intermediate leg portion 312 disposed to protrude from an outer side of the upper first base portion 311 toward the upper magnetic core 30,
wherein the upper second segment body 320 comprises:
a flat plate-shaped upper second base portion 321;
an upper second intermediate leg portion 322 disposed to protrude from the upper second base portion 321 toward the lower magnetic core 20 to be internally inserted into the other side of the second hollow portion C2 of the secondary coil 120; and
a pair of upper second outer leg portions 323 that are spaced apart from the upper second intermediate leg portion 322 disposed to protrude from an outer side of the upper second base portion 321 toward the lower magnetic core 20,
wherein upper first intermediate leg portion 312 and the upper second intermediate leg portion 322 that maintain the upper heat dissipation gap 30g are internally inserted into the second hollow portion C2 of the secondary coil 120, and
wherein the secondary coil 120 is internally inserted into a space between the upper first intermediate leg portion 312 and the upper first outer leg portion 313 and a space between the upper second intermediate leg portion 322 and the upper second outer leg portion 323 at the same time.

3. The transformer of claim 2, wherein an inner surface 210i of the lower first segment body 210 on which the lower first base portion 211, the lower first intermediate leg portion 212, and the lower first outer leg portion 213 face the lower second segment body 220 is formed as a flat surface,
wherein an inner surface 220i of the lower second segment body 220, which is a surface opposite to the inner surface 210i of the lower first segment body 210, and on which the lower second base portion 221, the lower second intermediate leg portion 222 and the lower second outer leg portion 223 face the lower first segment body 210 is formed as a flat surface,
wherein the lower heat dissipation gap 20g is formed between the inner surface 210i of the lower first segment body 210 and the inner surface 220i of the lower second segment body 220,
wherein an inner surface 310i of the upper first segment body 310 on which the upper first base portion 311, the upper first intermediate leg portion 312, and the upper first outer leg portion 313 face the upper second segment body 320 is formed as a flat surface,
wherein an inner surface 320i of the upper second segment body 320, which is a surface opposite to the inner surface 310i of the upper first segment body 310, and on which the upper second base portion 321, the upper second intermediate leg portion 322 and the upper second outer leg portion 323 face the upper first segment body 310 is formed as a flat surface, and
wherein the upper heat dissipation gap 30g is formed between the inner surface 310i of the upper first segment body 310 and the inner surface 320i of the upper second segment body 320.

4. The transformer of claim 2, further comprising:
a lower mount 130 for holding the primary coil 110 by being externally inserted into the lower first intermediate leg portion 212 and the lower second intermediate leg portion 222 at the same time, and being internally inserted into the first hollow portion C1 of the primary coil 110 while allowing the lower first segment body 210 and the lower second segment body 220 to maintain a lower heat dissipation gap 20g; and
an upper mount 150 for holding the secondary coil 120 by being externally inserted into the upper first intermediate leg portion 312 and the upper second intermediate leg portion 322 at the same time, and being internally inserted into the second hollow portion C2 of the secondary coil 120 while allowing the upper first segment body 310 and the upper second segment body 320 to maintain an upper heat dissipation gap 30g.

5. The transformer of claim 4, wherein the lower mount 130 comprises:
a flat lower plate 131 having a lower central hole 131a disposed at the center thereof and being in surface contact with the lower first base portion 211 and the lower second base portion 221 at the same time;
a circular tube-shaped lower support tube 132 disposed to protrude from the lower central hole 131a toward the primary coil 110 so as to hold the primary coil 110 while forming a lower through hole 132a that communicates with the lower central hole 131a of the lower plate 131 to be internally inserted into the first hollow portion C1 of the primary coil 110;
a lower first wing 134 disposed to protrude from a front edge of the lower plate 131 toward the lower first segment body 210, and being in close contact with the outer surface 211j of the lower first base portion 211 to hold an outer side of the lower first segment body 210;
a lower second wing 135 disposed to protrude from a rear edge of the lower plate 131 toward the lower second segment body 220 and being in close contact with the outer surface 221j of the lower second base portion 221 to hold an outer side of the lower second segment body 220; and
a lower spacer 133 disposed to protrude from the lower plate 131 toward the lower magnetic core 20 between the lower first wing 134 and the lower second wing 135 so as to support the lower first segment body 210 and the lower second segment body 220 and maintain a lower heat dissipation gap 20g between the lower first segment body 210 and the lower second segment body 220,
wherein the lower first segment body 210 is inserted between the lower spacer 133 and the lower first wing 134 such that the inner surface 210i is supported by the lower spacer 133 and the outer surface is supported by the lower first wing 134,
wherein the lower second segment body 220 is inserted between the lower spacer 133 and the lower second wing 135 such that the inner surface 220i is supported by the lower spacer 133 and the outer surface is supported by the lower second wing 135,
wherein the lower first intermediate leg portion 212 and the lower second intermediate leg portion 222 are internally inserted into the lower support tube 132 at the same time, such that the lower first segment body 210 and the lower second segment body 220 are provided in the lower mount 130 while maintaining a lower heat dissipation gap 20g as large as the lower spacer 133,
wherein the upper mount 150 comprises:
a flat upper plate 151 having an upper central hole 151a disposed at the center thereof;
a circular tube-shaped upper support tube 152 disposed to protrude from the upper central hole 151a toward the secondary coil 120 so as to hold the secondary coil 120 while forming an upper through hole 152a that communicates with the upper central hole 151a of the upper plate 151 to be internally inserted into the second hollow portion C2 of the secondary coil 120;
an upper first wing 154 disposed to protrude from a front edge of the upper plate 151 toward the upper first segment body 310 and being in close contact with the outer surface 311j of the upper first base portion 311 to hold an outer side of the upper first segment body 310;
an upper second wing 155 disposed to protrude from a rear edge of the upper plate 151 toward the upper second segment body 320 and being in close contact with the outer surface 321j of the upper second base portion 321 to hold an outer side of the upper second segment body 320; and
an upper spacer 153 disposed to protrude from the upper plate 151 toward the lower magnetic core 20 between the upper first wing 154 and the upper second wing 155 so as to support the upper first segment body 310 and the upper second segment body 320 and maintain a lower heat dissipation gap 20g between the upper first segment body 310 and the upper second segment body 320,
wherein the upper first segment body 310 is inserted between the upper spacer 153 and the upper first wing 154 such that the inner surface 310i is supported by the upper spacer 153 and the outer surface is supported by the upper first wing 154,
wherein the upper second segment body 320 is inserted between the upper spacer 153 and the upper second wing 155 such that the inner surface 320i is supported by the upper spacer 153 and the outer surface is supported by the upper second wing 155, and
wherein the upper first intermediate leg portion 312 and the upper second intermediate leg portion 322 are internally inserted into upper support tube 152 at the same time, such that the upper first segment body 310 and the upper second segment upper 320 are provided in the upper mount 150 while maintaining an upper heat dissipation gap 30g as large as the upper spacer 153.

6. The transformer of claim 4, further comprising:
a main mount 140 having a lower side that is axially inserted and provided into the lower support tube 132 of the lower mount 130, and an upper side that is axially inserted and provided into the upper support tube 152 of the upper mount 150 so as to connect between the lower mount 130 and the upper mount 150.

7. The transformer of claim 6, wherein the main mount 140 comprises:
a circular flat plate-shaped partition plate 141 having a main central hole 141a disposed at the center thereof to partition the primary coil 110 and the secondary coil 120;
a circular tube-shaped main lower support tube 142 having a main lower through hole 142a disposed to communicate with the main central hole 141a of the partition plate 141, and protruding from the main central hole 141a toward the primary coil 110 so as to be internally inserted into the first hollow portion C1 of the primary coil 110, and axially inserted and provided into the lower support tube 132 of the lower mount 130 to hold an upper side of the primary coil 110 at the same time; and
a circular tube-shaped main upper support tube 143 having a main upper through hole 143a disposed to communicate with the main central hole 141a of the partition plate 141, and protruding from the main central hole 141a toward the secondary coil 120 so as to be internally inserted into the second hollow portion C2 of the secondary coil 120, and axially inserted and provided into upper support tube 152 of the upper mount 150 to hold a lower side of the secondary coil 120 at the same time,
wherein the primary coil 110 is inserted between the lower plate 131 and the partition plate 141 while being mounted on the lower plate 131 in a height direction, and the first hollow portion C1 is externally inserted and fitted into the lower support tube 132 and the main lower support tube 142 in a radial direction,
wherein the secondary coil 120 is inserted between the partition plate 141 and the upper plate 151 while being mounted on the partition plate 141 in a height direction, and the second hollow portion C2 is inserted and fitted into the upper support tube 152 and the main upper support tube 143 in a radial direction,
wherein the lower first segment body 210 and the lower second segment body 220 are internally inserted into the first hollow portion C1 of the primary coil 110 by internally inserting the lower first intermediate leg portion 212 and the lower second intermediate leg portion 222 simultaneously into the lower support tube 132 and the main lower support tube 142 mutually arranged below the lower mount 130, and
wherein the upper first segment body 310 and the upper second segment body 320 are internally inserted into the second hollow portion C2 of the secondary coil 120 by internally inserting the upper first intermediate leg portion 312 and the upper second intermediate leg portion 322 into the upper support tube 152 and the main upper support tube 143 mutually arranged above the main mount 140.

8. The transformer of claim 7, wherein a lower step edge 142c is disposed on an outer circumferential surface of the main lower support tube 142,
wherein an upper step edge 143c is disposed on an outer circumferential surface of the main upper support tube 143,
wherein the lower step edge 142c of the main lower support tube 142 is supported by a step on an upper end of the lower support tube 132 such that the main lower support tube 142 and the lower support tube 132 are arranged in an overlapping manner,
wherein an outer circumferential surface of the lower support tube 132 and an outer circumferential surface of the main lower support tube 142 form the same surface while the main lower support tube 142 and the lower support tube 132 are arranged in an overlapping manner,
wherein a lower end of the upper support tube 152 is supported by a step on the upper step edge 143c of the main upper support tube 143 such that the main upper support tube 143 and the upper support tube 152 are arranged in an overlapping manner, and
wherein an outer circumferential surface of the upper support tube 152 and an outer circumferential surface of the main upper support tube 143 form the same surface while the main upper support tube 143 and the upper support tube 152 are arranged in an overlapping manner.

9. The transformer of claim 7, wherein a main lower fitting groove 142b is disposed to be concave on a circumferential edge of the main lower support tube 142,
wherein a lower fitting protrusion 132b is disposed to fit into the main lower fitting groove 142b on an inner circumferential surface of the lower support tube 132 of the lower mount 130,
wherein a main upper fitting groove 143b is disposed to be concave on an outer peripheral edge of the main upper support tube 143, and
wherein an upper fitting protrusion 152b is disposed to fit into the main upper fitting groove 143b on an inner circumferential surface of the upper support tube 152 of the upper mount 150.
